(19) United States
(12) Patent Application Publication
(10) Pub. No.: US 2017/0112187 A1
(43) Pub. Date: Apr. 27, 2017

(54) Wrapper With Integrated Sealing Means

(71) Applicant: John Ostrander, Woodbridge, NJ (US)

(72) Inventor: John Ostrander, Woodbridge, NJ (US)

(21) Appl. No.: 15/256,180

(22) Filed: Sep. 2, 2016

Related U.S. Application Data
(63) Continuation-in-part of application No. 15/219,061, filed on Jul. 25, 2016.
Application No. 15/219,061 is a continuation-in-part of application No. PCT/IB2016/054654, filed on Aug. 22, 2016.
(60) Provisional application No. 62/245,153, filed on Oct. 22, 2015.

(51) Int. Cl. A24D 1/02; B32B 7/12; B32B 29/00; B32B 7/06

(52) U.S. Cl. CPC A24D 1/022; B32B 7/06; B32B 7/12; B32B 29/002; A24D 1/025

(57) ABSTRACT

A pliable sheet used as a wrapper, such as a rolling paper or blunt wrap, includes an adhesive coating positioned along a first surface. The adhesive coating is positioned at a first edge of the pliable sheet, allowing the pliable sheet to be sealed in a rolled configuration by pressing the first edge against a bottom, opposite surface of the pliable sheet. A release liner covers the adhesive coating until ready for use. The pliable sheet can be rolled into a cylindrical shape or a conical shape. The shape is held by the adhesive coating bonding adjacent surfaces of the pliable sheet.

The current application is a continuation-in-part that claims a priority to the U.S. Utility patent application Ser. No. 15/219,061 filed on Jul. 25, 2016, which in turn claims a priority to the U.S. Provisional Patent application Ser. No. 62/245,153 filed on Oct. 22, 2015.

### FIELD OF THE INVENTION

The present invention relates generally to a wrapper that includes adhesives to help hold the wrapper in a rolled configuration.

### BACKGROUND OF THE INVENTION

Smoking, for example cigarettes, cigars, and even blunts, remains popular in the early 21^{st} century despite many laws that target or prohibit smoking. For example, a tax exists explicitly for cigarettes and cigars. The high prices created by the taxes have driven many persons to take to rolling their own cigarettes, accomplished by buying tobacco (and other herbal substances) and rolling papers or blunt wraps separately. While there may be some obstacles in taking the route of rolling one's own tobacco or other herbs, it remains an attractive alternative for a significant number of people.

Rolling a cigarette or similar item requires an element of skill. Many first attempts produce less than ideal results. To help with this, instructional material has been produced and disseminated in text and video formats to help newcomers improve their ability to roll a cigarette. However, manufacturers of rolling papers and blunt wraps can do more to make the process easier.

One way to facilitate the rolling process is by making it easier to seal a rolling paper or blunt wrap in a rolled state. Many ways of doing this currently exist, for example licking an edge of the rolling paper or blunt wrap to help it stick. While many of the current methods work well enough, there remains room for improvement. The aforementioned example of licking, for one, is a potential health concern and a more sanitary means is desirable.

The present invention seeks to provide a wrapper with integrated sealing means, providing an all-in-one solution for rolling and sealing tobacco and other smokable substances within a rolling paper. The solution provided by the present invention is easy to use as well as effective, resulting in a more user-friendly and healthier rolling process.

### BRIEF DESCRIPTION OF THE DRAWINGS

FIG. 1 is an exploded illustration showing the present invention in an unrolled configuration.

FIG. 2 is an illustration showing the present invention in the unrolled configuration.

FIG. 3 is an illustration showing the present invention in the unrolled configuration, with a release liner being removed from an adhesive coating.

FIG. 4 is an illustration showing the present invention being transitioned from the unrolled configuration into a rolled configuration.

FIG. 5 is an illustration showing the present invention in the rolled configuration with a cylindrical shape.

FIG. 6 is an illustration showing the present invention in the rolled configuration with a conical shape.

### DETAIL DESCRIPTIONS OF THE INVENTION

All illustrations of the drawings are for the purpose of describing selected versions of the present invention and are not intended to limit the scope of the present invention.

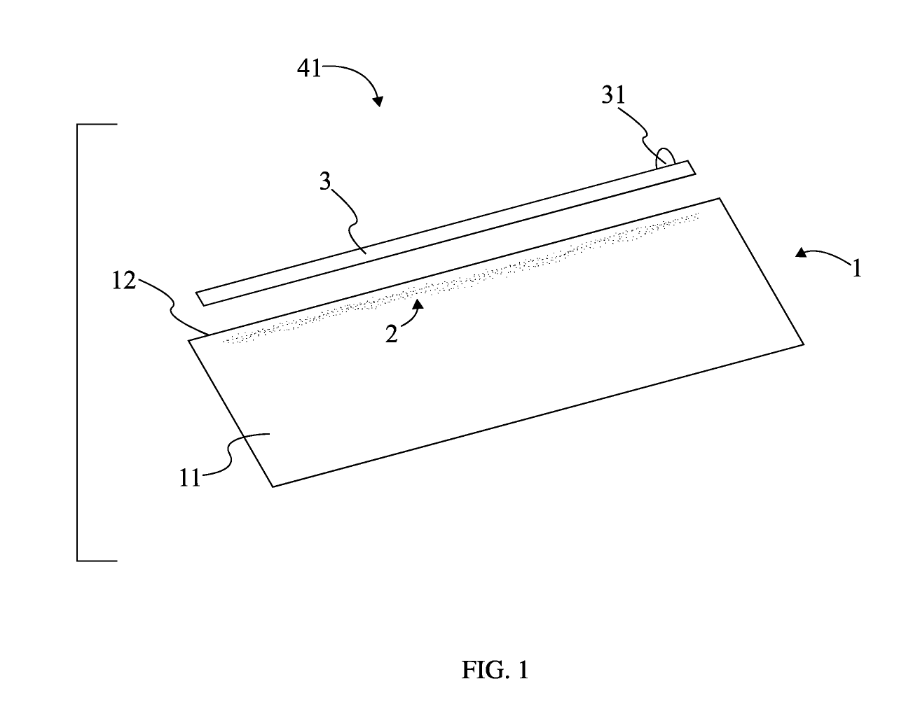

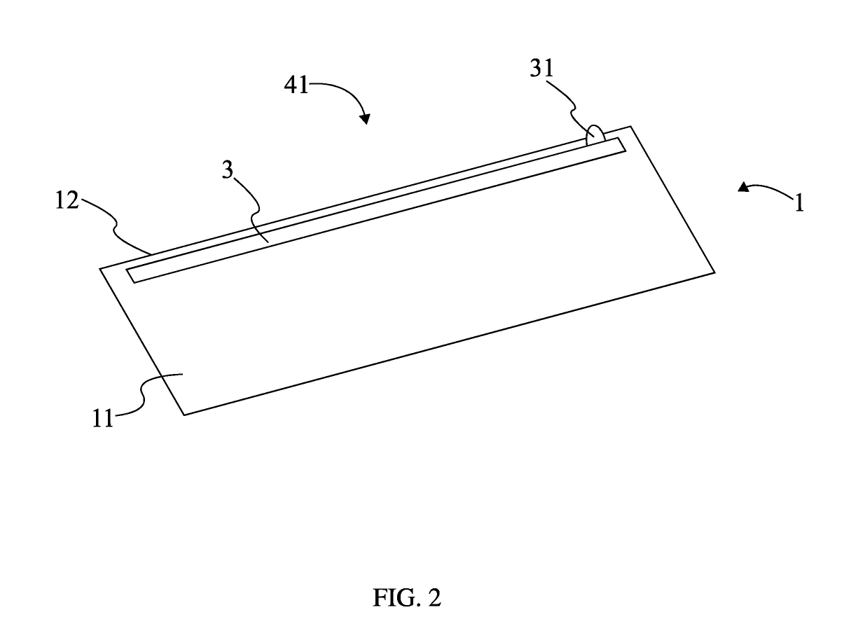

The present invention is a wrapper with integrated sealing means. The term wrapper encompasses both rolling papers and blunt wraps, as well as any sort of sheet which is used to wrap a smokable substance. The present invention allows for a person to easily enclose a smokable substance into a food-safe container. The integrated sealing means ensures that the wrapper maintains a desired shape once rolled about the smokable substance. To this end, the present invention comprises a pliable sheet 1, an adhesive coating 2, and a release liner 3. The pliable sheet 1 receives a smokable substance and can be rolled about said smokable substance. The adhesive coating 2 is applied along the pliable sheet 1, and help secures to free ends of the pliable sheet 1 to maintain a desired smoking wrapper, as later described. The release liner 3 is provided to preserve the adhesive coating 2 during storage while being easily removed from the adhesive coating 2 prior to use. These components are shown together in FIG. 1 and further illustrated via FIG. 2-FIG. 6.

Describing the core components of the present invention in more detail, the pliable sheet 1 comprises a first surface 11. The adhesive coating is positioned along a first edge 12, that is a “rolling” edge of the present invention. Further, the adhesive coating 2 is connected to the first surface 11. This allows the adhesive coating 2 to join the first surface 11 to another component (i.e. an opposite surface 13 or “bottom” of the pliable sheet 1) in certain configurations, as described later. The release liner 3 is detachable engaged with the adhesive coating 2. This allows the release liner 3 to preserve the adhesive coating 2 until ready for use, as earlier referenced.

It is noted that the distribution of the adhesive coating 2 can be altered in different embodiments of the present invention. For example, rather than being a strip along the first edge of the pliable sheet, as shown in FIG. 1, the adhesive coating 2 could be expanded to include adjacent edges of the pliable sheet 1, e.g. a top edge and a bottom edge. Potentially, the adhesive coating 2 could even be configured to form a shape or character, helping to enhance the aesthetics of the present invention. For example, the adhesive coating 2 could be positioned along the first surface in a tribal pattern, in line with a tribal motif for a certain brand or product line.

Regardless of any patterns or ornamentations that may be created with the adhesive coating 2, the adhesive coating 2 is preferably concentrated along an edge (e.g. the first edge 11) of the pliable sheet 1. This is because when the present invention is rolled up, said edge is pressed against the opposite surface 13, sealing the pliable sheet 1 in a rolled shape. If the adhesive coating 2 were centered on the pliable sheet 1, it would be less capable of holding the shape of the pliable sheet 1. Further, since combustible materials (e.g. tobacco or cannabis) are meant to be placed on the pliable sheet 1 prior to rolling, a central placement of the adhesive coating 2 would interfere the present invention's intended purpose.

The adhesive coating 2 itself is preferably a pressure-sensitive adhesive 21. A pressure-sensitive adhesive 21 is desired as it allows for a user to simply press one end of the pliable sheet 1 against the opposite surface 13 in order to seal the present invention. While other types of adhesive coatings 2 are possible, they often have drawbacks that make them unsuitable for the present invention. For example, solvent adhesives typically require a drying period to allow them set; if a user does not hold them together for the duration of the drying period, the adhesive can fail. Other adhesive types require applications of heat or require curing to be effective. Pressure-sensitive adhesives 21, conversely, do not require such applications of heat or a curing period. Instead, as their name implies, a simple application of pressure is sufficient to instantly secure two surfaces to each other.

In an unrolled configuration 4, the pliable sheet 1 is flat. That is, the pliable sheet 1 is formed into a planar body 41, as shown in FIG. 1-FIG. 3. In this configuration, the release liner 3 is positioned along the adhesive coating 2. The release liner 3 prevents the adhesive coating 2 from drying out, helping to maintain the stickiness of the adhesive coating 2 prior to use. Additionally, the release liner 3 prevents the adhesive coating 2 from accidently contacting and sticking to a foreign object. Thus, the release liner 3 extends the storage lifespan of the present invention, as well as increases user-friendliness of the present invention.

In this unrolled configuration 4, the present invention may be packaged individually or in groups. For example, each individual wrapper could be sealed within a plastic film and sold independently. Alternatively, several sheets can be packaged together and sold together, such as in a box. Selling together, such as in a box, is often preferred by retailers as many customers will buy multiple wrappers at once, rather than buying a few at time.

The unrolled configuration 4, as described above, is desirable for storage and retail as it is more space efficient than a rolled configuration 5. The advantages of the unrolled configuration 4 are even more pronounced when taking into account the adhesive coating 2; if the present invention were supplied in a rolled configuration 5, with two edges joined together by the adhesive coating 2, the shelf-life would be reduced due to exposure of the adhesive coating 2. Thus, the unrolled configuration 4 is the preferred vending and storage configuration for the present invention.

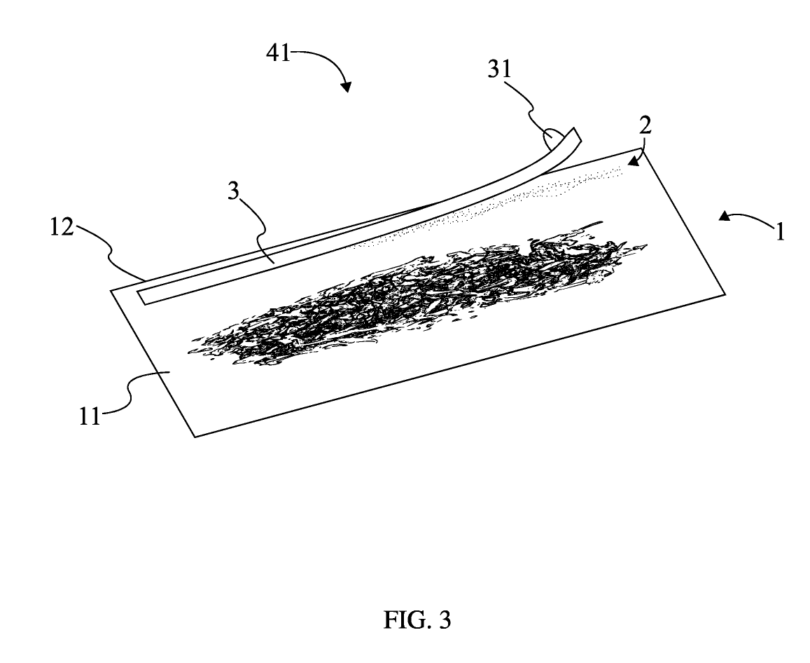

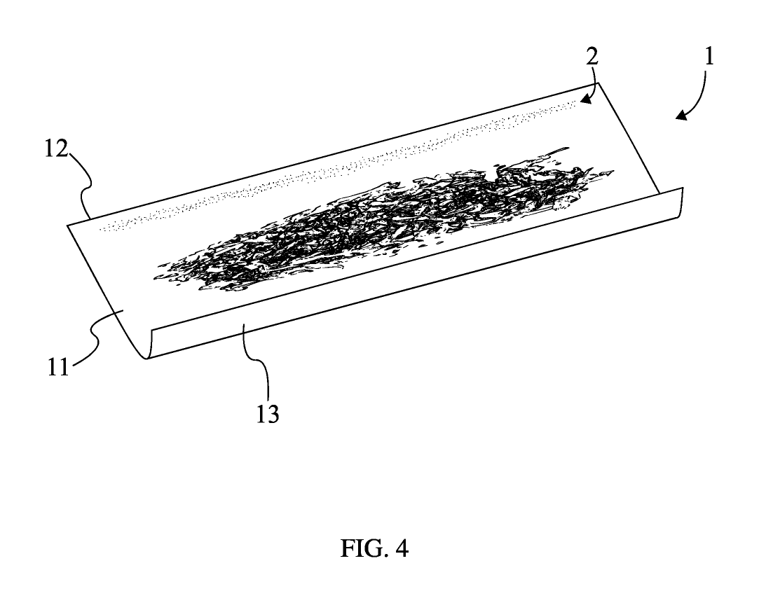

When a user is ready to envelope a smokable substance with the present invention, the present invention is positioned into a rolled configuration 5. The rolled configuration 5 allows for aforementioned smokable substance to be contained with the present invention and easily smoked. The transition from the unrolled configuration 4 to the rolled configuration 5 is facilitated by the adhesive coating 2 and the release liner 3. After placing a smokable substance on the first surface 11, a user removes the release liner 3 and rolls the first edge 11 of the present invention towards an opposite edge. The adhesive coating 2, positioned along the first edge 11, is then pressed against the opposite surface 13 of the present invention. This pressure allows the adhesive coating 2 to join the first surface 11 to the opposite surface 13. The process of transitioning from the unrolled configuration 4 to the rolled configuration 5 is shown via FIG. 3 and FIG. 4. The smokable substance is effectively placed in a combustion chamber 53 created by the rolled configuration. The combustion chamber 53, where burning of the smokable substance takes place, is bounded by the first surface 11 as the pliable sheet 1 is rolled about the smokable substance.

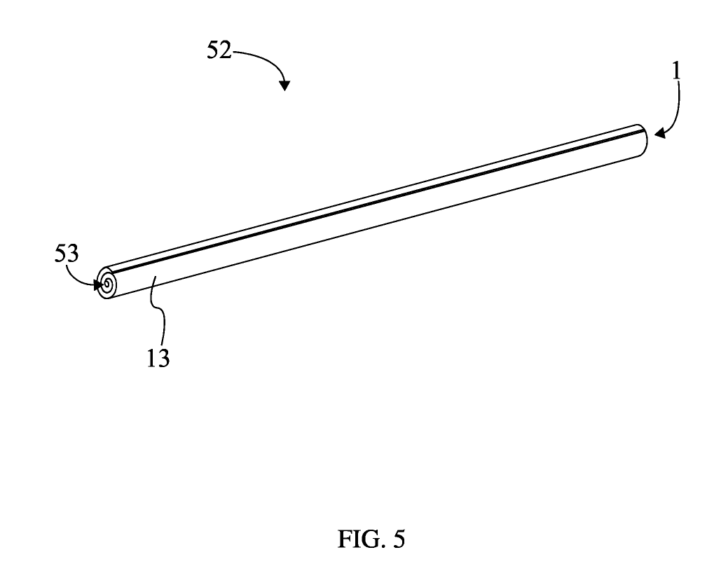

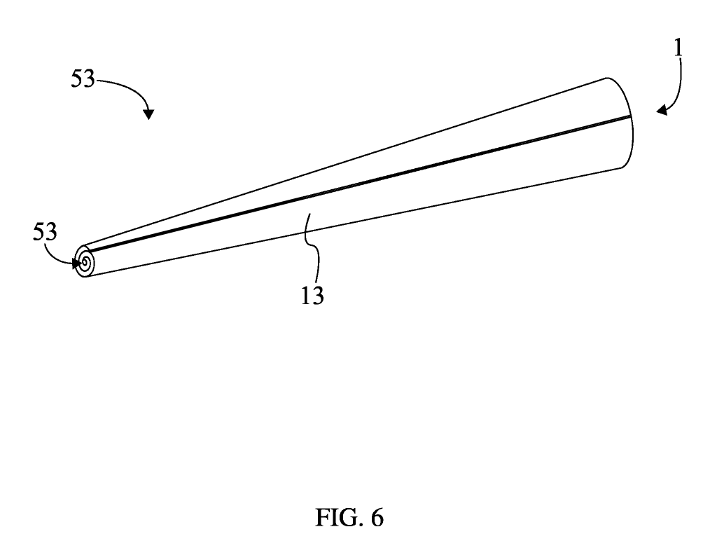

Depending on the preferences of a user, different shapes are possible for the pliable sheet 1 in the rolled configuration 5. For example, in one embodiment as shown in FIG. 5, the pliable sheet 1 is formed into a cylindrical body 51. In this embodiment, the pliable sheet 1 is rolled to the same diameter at each end. In another embodiment, shown in FIG. 6, the pliable sheet 1 is rolled into a conical body 52. In this embodiment, the pliable sheet 1 is rolled to be narrow at one end while widening towards the other end. These are two shapes commonly used with wrappers, though ultimately any tubular shape capable of receiving a smokable substance is compatible with the present invention.

To make it easier for a user to separate the release liner 3 from the adhesive coating 2, the present invention preferably comprises a tab 31. The tab 31 is adjacently connected to the releaser liner 3. Ideally, the tab 31 is positioned next to the pliable sheet 1, making it easier for a user to grab the tab 31. In short, the tab 31 increases user friendliness by providing a convenient interface for the release liner 3. Without the tab 31, a user has to struggle with lifting a corner of the release liner 31 in order to remove the release liner 3 from the adhesive coating 2. With the tab 31, a user is instead able to grab the tab 31 and easily pull the release liner 3 away from the adhesive coating 2.

The adhesive coating 2 itself may be derived from a variety of sources. For example, in an embodiment in which it might be desirable to advertise the product being 100% natural, the adhesive coating is created from plant-extracted oils.

Of course, other compositions for the adhesive coating 2 remain possible within the present invention. Indeed, any composition that allows for two surfaces to be adhered to each other is within the scope of the present invention.

Along these lines, the composition of the pliable sheet 1 itself is variable. For example, wrappers can be derived from wood pulp, hemp, flax, and even rice. There is variety even within these choices, for example the genus of tree that the wood pulp is produced from. The type of material can be tied in with the source for the adhesive coating 2; as an example, if eucalyptus oil were used for formation of the adhesive coating 2, wood chips from a eucalyptus tree could be used for manufacture of the pliable sheet. This would allow for advertising of a wrappers that is completed derived from eucalyptus.

Although the invention has been explained in relation to its preferred embodiment, it is to be understood that many other possible modifications and variations can be made without departing from the spirit and scope of the invention as hereinafter claimed.

1. A wrapper with integrated sealing member comprises:
a pliable sheet;
an adhesive coating;
a release liner;
the pliable sheet comprises a first surface and a first edge;
the adhesive coating being positioned along the first edge of the pliable sheet;
the adhesive coating being connected to the first surface; and
the release liner being detachably engaged with the adhesive coating.

2. The wrapper with integrated sealing member as claimed in claim 1 comprises:
the adhesive coating being a pressure-sensitive adhesive.

3. The wrapper with integrated sealing member as claimed in claim 1 comprises:
wherein the pliable sheet is in an unrolled configuration; and
the release liner being positioned onto the adhesive coating.

4. The wrapper with integrated sealing member as claimed in claim 3, where the pliable sheet is formed into a planar body.

5. The wrapper with integrated sealing member as claimed in claim 1 comprises:
wherein the pliable sheet is in a rolled configuration;
the pliable sheet further comprises an opposite surface;
the adhesive coating being positioned on the first surface; and
the first surface being pressed against the opposite surface, wherein the first surface is adhered to the opposite surface by the adhesive coating.

6. The wrapper with integrated sealing member as claimed in claim 5, wherein the pliable sheet is formed into a cylindrical body.

7. The wrapper with integrated sealing member as claimed in claim 5, wherein the pliable sheet is formed into a conical body.

8. The wrapper with integrated sealing member as claimed in claim 5 comprises:
a combustion chamber being delineated by the first surface, wherein a combustible material is burned within the combustion chamber.

9. The wrapper with integrated sealing member as claimed in claim 1 comprises:
a release tab;
the release tab being adjacently connected to the release liner; and
the release tab being positioned adjacent to the pliable sheet.
